(19) United States
(12) Patent Application Publication
(10) Pub. No.: US 2026/0122195 A1
(43) Pub. Date: Apr. 30, 2026

(54) IMAGE FORMING APPARATUS, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Tomoki MAEKAWA, SHIOJIRI-SHI (JP); Yasuhiro FURUTA, SHIMOSUWA-MACHI (JP); Akihiko SATOMI, SHIOJIRI-SHI (JP)

(21) Appl. No.: 19/043,708

(22) Filed: Feb. 3, 2025

(30) Foreign Application Priority Data
Feb. 6, 2024 (JP) 2024-016466

(51) Int. Cl. H04N 1/44; H04N 1/00

(52) U.S. Cl. CPC H04N 1/4426; H04N 1/00244; H04N 2201/0094

(57) ABSTRACT

An image forming apparatus according to the present disclosure is an image forming apparatus connected to a cloud server that provides a cloud service, the image forming apparatus including a storage configured to store, in association with each other, card information of a card distributed to a legitimate user of the image forming apparatus and a token for enabling use of the cloud service, a card information acquisition unit configured to acquire card information of a card possessed by a target user who is a user about to use the cloud service via the image forming apparatus, and a service use unit configured to use the cloud service using the token stored in the storage in association with the acquired card information.

The present application is based on, and claims priority from JP Application Serial Number 2024-016466, filed Feb. 6, 2024, the disclosure of which is hereby incorporated by reference herein in its entirety.

### BACKGROUND

### 1. Technical Field

The present disclosure relates to an image forming apparatus, an information processing method, and a non-transitory computer-readable storage medium storing a program.

### 2. Related Art

In recent years, cloud services have been spread. According to the spread of the cloud services, a technique for using the cloud services via an image forming apparatus such as a printer has been proposed. For example, JP-A-2022-140537 discloses a technology of accessing a file or a folder of a storage of a cloud service from an image forming apparatus.

JP-A-2022-140537 is an example of the related art.

In the technique disclosed in JP-A-2022-140537, a user needs to perform authentication operation for using the cloud service in order to use the cloud service via the image forming apparatus. That is, the user needs to always perform input operation for login information for use of the cloud service to the image forming apparatus. For this reason, convenience of the user for the use of cloud services is low.

### SUMMARY

An image forming apparatus according to the present disclosure is an image forming apparatus connected to a server that provides a cloud service, the image forming apparatus including: a storage unit configured to store, in association with each other, card information of a card distributed to a legitimate user of the image forming apparatus and a token for enabling use of the cloud service; a card information acquisition unit configured to acquire card information of a card possessed by a target user who is a user about to use the cloud service via the image forming apparatus; and a service use unit configured to use the cloud service using the token stored in the storage unit in association with the acquired card information.

An information processing method according to the present disclosure is an information processing method of an image forming apparatus connected to a server that provides a cloud service, the information processing method including: storing, in association with each other, card information of a card distributed to a legitimate user of the image forming apparatus and a token for enabling use of the cloud service; acquiring card information of a card possessed by a target user who is a user about to use the cloud service via the image forming apparatus; and using the cloud service by using the token stored in association with the acquired card information.

A non-transitory computer-readable storage medium storing a program according to the present disclosure is a non-transitory computer-readable storage medium storing a program for causing a computer of an image forming apparatus connected to a server, which provides a cloud service, to execute: a storage processing step of storing, in association with each other, in a storage unit, card information of a card distributed to a legitimate user of the image forming apparatus and a token for enabling use of the cloud service; a card information acquisition step of acquiring card information of a card possessed by a target user who is a user about to use the cloud service via the image forming apparatus; and a service use step of using the cloud service by using the token stored in the storage unit in association with the acquired card information.

### BRIEF DESCRIPTION OF THE DRAWINGS

FIG. 1 is a block diagram illustrating an example of a configuration of an information processing system according to an embodiment.

FIG. 2 is a block diagram illustrating an example of a functional configuration of an image forming apparatus according to the embodiment.

FIG. 3 is a diagram illustrating a specific example of information stored in a storage unit.

FIG. 4 is a block diagram illustrating an example of a hardware configuration of the image forming apparatus according to the embodiment.

FIG. 5A is a flowchart illustrating a flow of processing of the image forming apparatus according to the embodiment.

FIG. 5B is a flowchart illustrating the flow of the processing of the image forming apparatus according to the embodiment.

FIG. 6 is a diagram illustrating a specific example of information stored in the storage unit.

FIG. 7 is a diagram illustrating a specific example of information acquired from a cloud server in first confirmation processing.

FIG. 8 is a diagram illustrating a specific example of information stored in the storage unit.

FIG. 9 is a diagram schematically illustrating deletion of invalid information.

FIG. 10 is a diagram illustrating a specific example of information stored in the storage unit.

FIG. 11 is a diagram illustrating a specific example of information stored in the storage unit.

### DESCRIPTION OF EMBODIMENTS

An embodiment is explained below with reference to the drawings. To clarify the explanation, the following description and the drawings are omitted or simplified as appropriate. In the drawings, the same elements are denoted by the same reference numerals and signs and redundant explanation of the elements is omitted according to necessity.

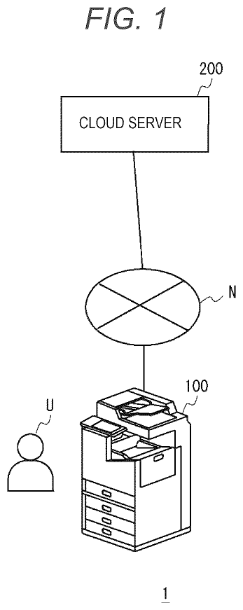

FIG. 1 is a block diagram illustrating an example of a configuration of an information processing system 1 according to the embodiment. In the example illustrated in FIG. 1, the information processing system 1 includes an image forming apparatus 100 and a cloud server 200. The image forming apparatus 100 and the cloud server 200 are connected to a network N such as the Internet.

In the present embodiment, the user U uses, via the image forming apparatus 100, a cloud service provided by the cloud server 200. In the present embodiment, a token for enabling use of the cloud service provided by the cloud server 200 is stored in the image forming apparatus 100. The image forming apparatus 100 uses the cloud service using the token. For this reason, a user U can use the cloud service without performing authentication operation for using the cloud service, that is, the input operation for login information for using the cloud service. Therefore, according to the present embodiment, it is possible to improve convenience of the user for the use of the cloud service. The image forming apparatus 100 permits use of functions of the image forming apparatus 100 and use of a cloud service via the image forming apparatus 100 only to the user U who has succeeded in user authentication by an authentication unit 104 explained below. For this reason, it is possible to securely operate the information processing system 1. In the present embodiment, basically, authentication by the authentication unit 104 is successful when a card ID (identification information of a card) input to the image forming apparatus 100 is registered in the cloud server 200. However, in other case, exceptionally, the authentication by the authentication unit 104 is successful when a predetermined condition is satisfied. Details of the present embodiment are explained below.

The cloud server 200 is a server that provides a predetermined cloud service. The provided service is, for example, a data storage service. In this case, the cloud service is used via the image forming apparatus 100 as explained below. For example, the image forming apparatus 100 downloads data stored in the cloud server 200 with a data storage service provided as a cloud service and prints an image for the data. The image forming apparatus 100 stores image data generated by scanning a document in the cloud server 200 using the data storage service. The above is only an example of use of the cloud service via the image forming apparatus 100. Processing other than the above may be performed as the use of the cloud service via the image forming apparatus 100.

When login information acquired by the cloud server 200 according to implementation of input operation by the user U coincides with login information registered in advance for each user in the cloud server 200, the cloud server 200 permits the use of the cloud service by the user U. Specifically, the login information is a set of a user ID (user identification information) and a password and may be referred to as account information. When acquiring a token for enabling use of a cloud service and issued for each user, the cloud server 200 permits use of the cloud service by the user U corresponding to the token.

Here, the token explained above is explained more in detail. More specifically, the token explained above is a refresh token. In the present embodiment, two types of tokens including an access token and a refresh token are issued. The access token is information for certifying that access is access by a legitimate user. The refresh token is issued together with the access token when the access token is issued. Terms of validity are provided for both of the access token and the refresh token. That is, these tokens are valid until a predetermined time elapses from a point in time when the tokens are issued. Whereas the term of validity of the access token is as short as several hours, the term of validity of the refresh token is longer than the term of validity of the access token. In the present embodiment, the term of validity of the refresh token is 90 days as an example. The access token is issued when login information acquired by the cloud server 200 coincides with login information registered in advance for each user in the cloud server 200 and when the cloud server 200 acquires the refresh token. That is, the refresh token is information that can be used instead of the login information in order to issue the access token. The cloud server 200 permits use of the cloud service in response to a use request from the image forming apparatus 100 using the access token. As described above, when the refresh token is used, the access token is issued. For this reason, the refresh token can be considered as information for enabling use of the cloud service. By using the refresh token, authentication operation for using the cloud service, that is, input operation for login information for use of the cloud service can be omitted. Therefore, the refresh token is also considered as information for omitting authentication necessary when using the cloud service. The refresh token can also be considered as information used instead of the login information. In the following explanation, the refresh token is simply referred to as “token”.

In the cloud server 200, card information of a card distributed to a legitimate user of the image forming apparatus 100 is registered in association with a user ID (user identification information) of the user. That is, the card information of the card distributed to the legitimate user of the image forming apparatus 100 and the user ID of the user who is also a user of the cloud service are registered in association with each other in the cloud server 200. In other words, in the cloud server 200, the user ID of the legitimate user of the cloud service and the card information of the user are registered in association with each other. Here, in the present embodiment, the card information is more specifically a card ID (card identification information). The registration of the card information is implemented by, for example, registration operation for the cloud server 200 by an administrator. However, it is also possible that the card information is not registered in the cloud server 200 for a part or all of cards distributed to the legitimate user of the image forming apparatus 100 for some reasons, for example, because the administrator neglects the registration operation.

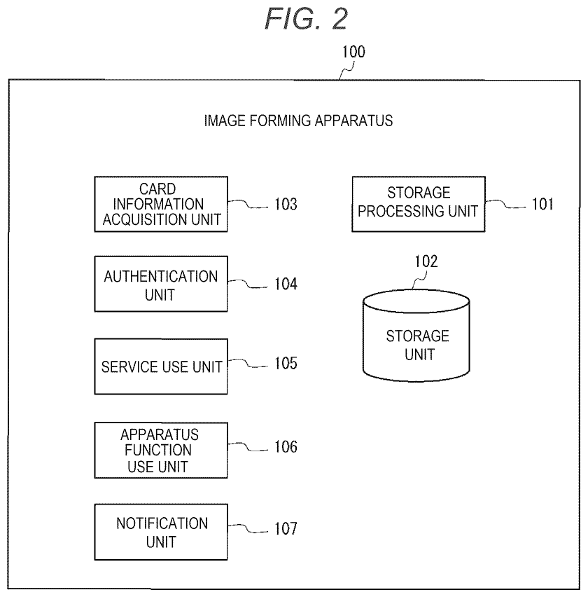

Subsequently, details of the image forming apparatus 100 are explained. The image forming apparatus 100 is connected to the cloud server 200, which is a server that provides a cloud service, via a network N. FIG. 2 is a block diagram illustrating an example of a functional configuration of the image forming apparatus 100. As illustrated in FIG. 2, the image forming apparatus 100 includes a storage processing unit 101, a storage unit 102, a card information acquisition unit 103, an authentication unit 104, a service use unit 105, an apparatus function use unit 106, and a notification unit 107.

The storage processing unit 101 performs processing of causing the storage unit 102 to store information. For example, the storage processing unit 101 performs processing for storing, in the storage unit 102, in association with each other, card information of a card distributed to a legitimate user of the image forming apparatus 100 and a token for enabling use of a cloud service. More specifically, the storage processing unit 101 stores, in the storage unit 102, in association with each other for each user, a card ID (card information) of a card distributed to a legitimate user of the image forming apparatus 100, a user ID (user identification information) of the user, a token for enabling use of a cloud service, and information indicating an issuance point in time of the token. More specifically, the token stored in the storage unit 102 is a refresh token issued based on legitimate login information or a refresh token issued based on the legitimate refresh token.

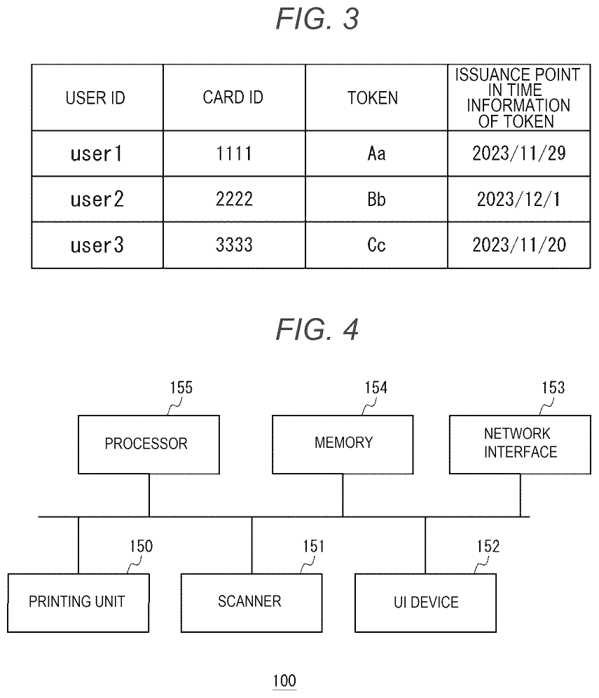

The storage unit 102 is a storage area for storing information used by the authentication unit 104 or the service use unit 105. FIG. 3 is a diagram illustrating a specific example of the information stored in the storage unit 102. As illustrated in FIG. 3, the information stored in the storage unit 102 is information in which a user ID, a card ID, a token, and information indicating an issuance point in time of the token (hereinafter referred to as “issuance point in time information”) are associated with one another for each user.

The card information acquisition unit 103 acquires card information of a card possessed by a target user. More specifically, the card information acquisition unit 103 acquires, as the card information, a card ID that is identification information of the card. Here, the target user means a user who is about to use, via the image forming apparatus 100, a cloud service provided by the cloud server 200. In the present embodiment, the user U corresponds to the target user. The card information acquisition unit 103 acquires a card ID via a UI device 152 explained below. More specifically, the card information acquisition unit 103 acquires a card ID read by the card reader provided with the image forming apparatus 100 as the UI device 152. The card information acquisition unit 103 may acquire a card ID input by the user U via an input device including the image forming apparatus 100 as the UI device 152.

The authentication unit 104 performs authentication processing of authenticating that the target user (the user U) is a legitimate user of the image forming apparatus 100. In the present embodiment, use of functions of the image forming apparatus 100 and use of a cloud service via the image forming apparatus 100 are permitted when a result of the authentication processing by the authentication unit 104 is authentication success. That is, when the result of the authentication processing is the authentication success, the authentication unit 104 permits the use of the functions of the image forming apparatus 100 and the use of the cloud service via the image forming apparatus 100 by the user U. When the result of the authentication processing is authentication failure, the authentication unit 104 prohibits the use of the functions of the image forming apparatus 100 and the use of the cloud service via the image forming apparatus 100 by the user U.

The authentication processing by the authentication unit 104 can include first confirmation processing, second confirmation processing, and third confirmation processing. The authentication processing performed on the user U includes all of these kinds of confirmation processing in some cases and includes only a part of these kinds of confirmation processing in other cases. Which confirmation processing is performed in what kind of a case is explained below with reference to a flowchart.

The first confirmation processing is processing of acquiring the user identification information (the user ID) registered in the cloud server 200 in correlation with the card information (the card ID) acquired by the card information acquisition unit 103. That is, in the first confirmation processing, processing of acquiring user identification information corresponding to the acquired card information (card ID) from the cloud server 200 among user identification information of a legitimate user of the cloud service registered in the cloud server 200 is performed.

The second confirmation processing is processing of confirming that the card information (the card ID) acquired by the card information acquisition unit 103 is stored in the storage unit 102. That is, in the second confirmation processing, processing of confirming that the card information acquired by the card information acquisition unit 103 is managed in the image forming apparatus 100 as card information of a card of the legitimate user of the image forming apparatus 100 is performed.

The third confirmation processing is processing of acquiring specific user identification information from the cloud server 200 and confirming that the acquired user identification information coincides with the user identification information stored in the storage unit 102 in association with the card information (the card ID) acquired by the card information acquisition unit 103. Here, the specific user identification information explained above is specifically user identification information of the legitimate user of the cloud service registered in the cloud server 200 in correlation with a token stored in the storage unit 102 in association with the card information (the card ID) acquired by the card information acquisition unit 103.

As illustrated in a flowchart explained below, when failing in the first confirmation processing, the authentication unit 104 determines whether a cause of the failure is due to an error in communication with the cloud server 200. When a response from the cloud server 200 is not obtained in the first confirmation processing, the authentication unit 104 determines that the cause of the failure in the first confirmation processing is a communication error. When, although a response is obtained, the user identification information (the user ID) registered in the cloud server 200 in correlation with the card information (the card ID) acquired by the card information acquisition unit 103 is not obtained, the authentication unit 104 determines that the cause of the failure in the first confirmation processing is other than the communication error.

The service use unit 105 performs, according to an instruction from the user U, processing of using the cloud service provided by the cloud server 200. When the result of the authentication processing by the authentication unit 104 for the user U is authentication success, the service use unit 105 executes use processing for the cloud service according to an instruction of the user U. In particular, in the present embodiment, the service use unit 105 uses the cloud service using the token stored in the storage unit 102 in association with the card information (the card ID) acquired by the card information acquisition unit 103. In this case, specifically, the service use unit 105 transmits a refresh token, which is a token stored in the storage unit 102, to the cloud server 200 and requests issuance of an access token and a new refresh token. When the image forming apparatus 100 receives the access token, the service use unit 105 transmits a use request of the cloud service to the cloud server 200 together with the access token to use the cloud service. For example, the service use unit 105 may download data from the cloud server 200 according to an instruction of the user or may upload image data generated by scanning to the cloud server 200.

When the image forming apparatus 100 receives a new refresh token, the storage processing unit 101 causes the storage unit 102 to store the new refresh token in association with the card information acquired by the card information acquisition unit 103. Accordingly, an old refresh token stored in association with the card information acquired by the card information acquisition unit 103 is updated to the new refresh token. The storage processing unit 101 causes the storage unit 102 to store issuance point in time information of the new refresh token in association with the card information acquired by the card information acquisition unit 103. Accordingly, old issuance point in time information stored in association with the card information acquired by the card information acquisition unit 103 is updated to the new issuance point in time information.

When using the cloud service, the service use unit 105 may not always use the token stored in the storage unit 102. Specifically, when the user U performs input operation for legitimate login information for use of the cloud service, the service use unit 105 uses the cloud service without using the token stored in the storage unit 102. In this case, the service use unit 105 transmits the login information to the cloud server 200 and requests issuance of an access token and a refresh token. When the image forming apparatus 100 receives an access token, the service use unit 105 transmits a use request for the cloud service to the cloud server 200 together with the access token to use the cloud service. In this case as well, the storage processing unit 101 stores the received refresh token and issuance point in time information of the refresh token in the storage unit 102 in association with the card information acquired by the card information acquisition unit 103.

The apparatus function use unit 106 performs, according to an instruction from the user U, processing of using the functions provided by the image forming apparatus 100. In the present embodiment, as an example, the apparatus function use unit 106 performs, according to an instruction from the user U, processing of using a print function by a printing unit 150 or a scan function by the scanner 151 explained below. When the result of the authentication processing by the authentication unit 104 for the user U is authentication success, the apparatus function use unit 106 executes, according to an instruction of the user U, processing of using the functions provided by the image forming apparatus 100.

When the remaining term of validity of the token specified from the issuance point in time information stored in the storage unit 102 is less than a predetermined threshold, the notification unit 107 notifies a predetermined message to a user corresponding to the token. Specifically, the notification unit 107 notifies, to the user, a message for informing that the term of validity of the token will end soon. The message may be a message for urging the user to use the cloud service via the image forming apparatus 100. In the present embodiment, more specifically, the notification unit 107 performs notification processing as explained below. The notification unit 107 checks whether there is a token, a term of validity of which will end soon, based on points in time (dates) indicated by respective pieces of issuance point in time information stored in the storage unit 102 and the present point in time (date). For example, the notification unit 107 checks whether there is a token, since issuance of which eighty days has elapsed. The check only has to be performed at any timing and, for example, may be performed every time the image forming apparatus 100 is turned on, may be performed when the authentication processing of the authentication unit 104 is performed first in one day, or may be performed every time predetermined time comes. When there is a token, a term of validity of which will end soon, the notification unit 107 acquires a mail address of a user corresponding to the token. In the present embodiment, the cloud server 200 manages mail addresses for each of registered users and the notification unit 107 inquires of the cloud server 200 about a mail address of a user. More specifically, the notification unit 107 inquires of a mail address using a token of the user stored in the storage unit 102. Then, the notification unit 107 transmits a mail of the message explained above using the mail address acquired as explained above. The mail address of the user may not always be acquired from the cloud server 200 and may be stored in the storage unit 102 or the like of the image forming apparatus 100 in advance.

Subsequently, an example of a hardware configuration of the image forming apparatus 100 is explained. FIG. 4 is a block diagram illustrating an example of a hardware configuration of the image forming apparatus 100. As illustrated in FIG. 4, the image forming apparatus 100 includes a printing unit 150, a scanner 151, a UI device 152, a network interface 153, a memory 154, and a processor 155.

The printing unit 150 has a printing function for forming an image on a printing medium such as paper. For example, the printing unit 150 includes a print engine. The print engine is a mechanical configuration for executing printing of an image on a print medium with coloring materials. The print engine may include, for example, a mechanism for performing printing using ink with an inkjet mechanism scheme. Alternatively, the print engine may include, for example, a mechanism for performing printing using toner with an electrophotographic scheme. The scanner 151 scans a document to generate image data. For example, the scanner 151 optically reads the document by scanning the document in a predetermined direction, that is, a sub scanning direction using a light source and a sensor and generates image data. The image forming apparatus 100 may include a conveyance mechanism for conveying a print medium on which printing is performed by the printing unit 150 or a document to be scanned by the scanner 151.

The UI device 152 is a device functioning as a user interface. Specifically, the UI device 152 is configured by a display that displays various information and an input device such as a keyboard or a pointing device that receives input operation from a user. The UI device may be configured as a touch panel in which a display and an input device are integrally configured.

The network interface 153 is used to perform communication via the network N. The network interface 153 may include, for example, a network interface card (NIC).

The memory 154 is configured by, for example, a combination of a volatile memory and a nonvolatile memory. The memory 154 is used to store a program or the like executed by the processor 155. The storage unit 102 explained above may be implemented by a storage device such as the memory 154. The memory 154 may include a plurality of memories.

The processor 155 reads a program from the memory 154 and executes the program. Accordingly, the processor 155 implements the functions of the storage processing unit 101, the card information acquisition unit 103, the authentication unit 104, the service use unit 105, the apparatus function use unit 106, and the notification unit 107 explained above. The processor 155 may be, for example, a microprocessor, a microprocessor unit (MPU), or a central processing unit (CPU). The processor 155 may include a plurality of processors. As explained above, the image forming apparatus 100 includes a configuration as a computer.

The cloud server 200 also includes a configuration as a computer. A processor of the cloud server 200 implements various functions of the cloud server 200 by reading a program from a memory of the cloud server 200 and executing the program.

The program includes an instruction group (or software codes) for causing a computer to perform one or more of the functions explained in the embodiment when the program is read in the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or devices based on other memory technologies, a CD-ROM, a digital versatile disc (DVD), a Blu-ray (trademark registered) disc, or other optical disc storages, a magnetic cassette, a magnetic tape, a magnetic disk storage or other magnetic storage devices. The program may be transmitted on a transitory computer-readable medium or a communication medium. Not as a limitation but as an example, the transitory computer-readable medium or the communication medium includes an electric, optical, or acoustic propagation signal or a propagation signal of another form.

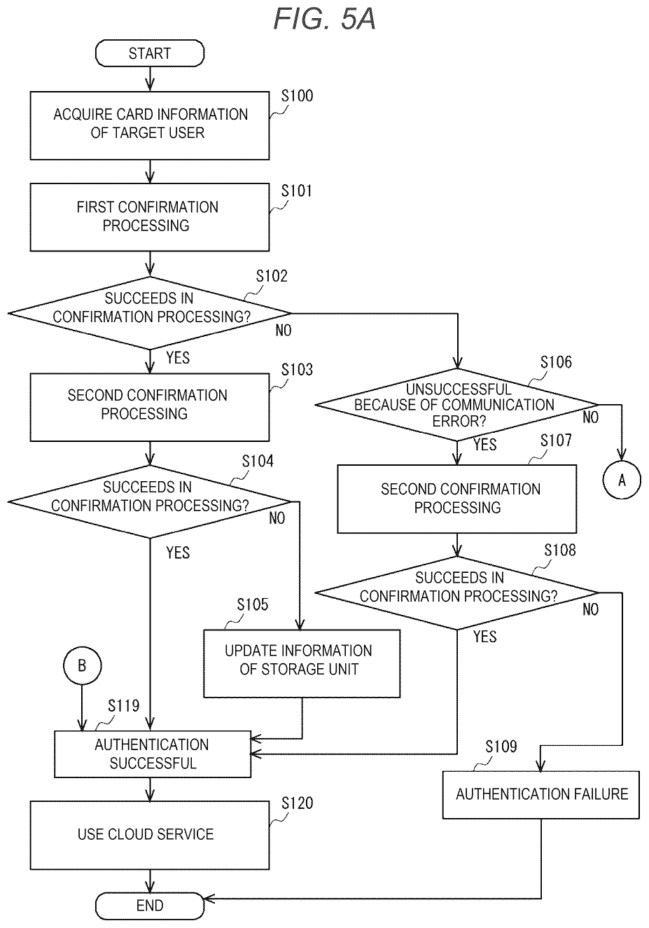

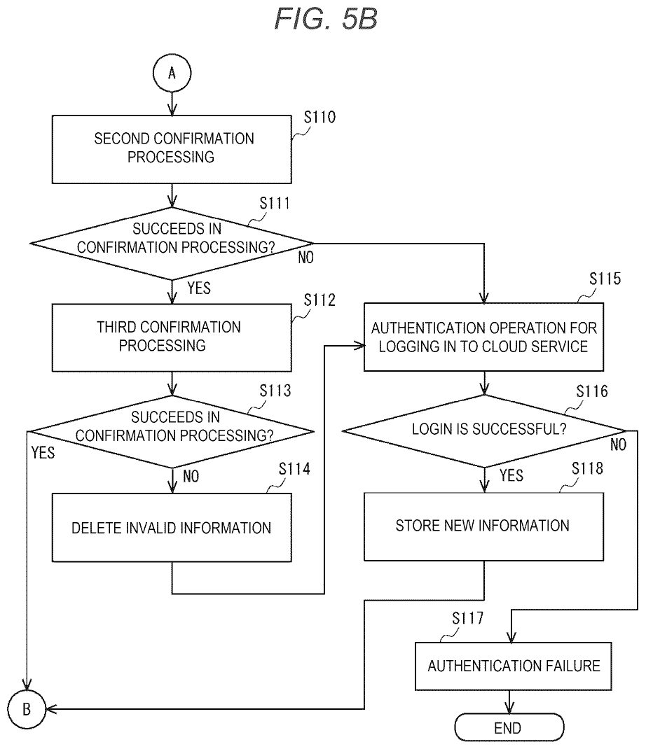

Subsequently, a flow of processing of the image forming apparatus 100 is explained. FIGS. 5A and 5B are flowcharts illustrating an example of the flow of the processing of the image forming apparatus 100. The flow of the processing is explained below with reference to FIGS. 5A and 5B.

In step S100, the card information acquisition unit 103 acquires card information, that is, a card ID of a card possessed by the user U who is the target user. After step S100, the authentication processing by the authentication unit 104 is performed in step S101 and subsequent steps.

In step S101, the authentication unit 104 executes the first confirmation processing. That is, the authentication unit 104 attempts to acquire a user ID registered in the cloud server 200 in correlation with the card ID acquired in step S100. That is, the authentication unit 104 inquires the cloud server 200 about a user ID registered in the cloud server 200 in correlation with the card ID acquired in step S100. Specifically, the authentication unit 104 requests the cloud server 200 to transmit the user ID corresponding to the card ID acquired in step S100. When the authentication unit 104 succeeds in the first confirmation processing, that is, when the user ID registered in the cloud server 200 in correlation with the card ID acquired in step S100 has been successfully acquired from the cloud server 200 (YES in step S102), the processing shifts to step S103. On the other hand, when the authentication unit 104 fails in the first confirmation processing, that is, when the user ID registered in the cloud server 200 in correlation with the card ID acquired in step S100 has not been successfully acquired from the cloud server 200 (NO in step S102), the processing shifts to step S106.

In step S103, the authentication unit 104 executes the second confirmation processing. That is, the authentication unit 104 checks whether the card ID acquired in step S100 is stored in the storage unit 102. When the authentication unit 104 succeeds in the second confirmation processing, that is, when the card ID acquired in step S100 is stored in the storage unit 102 (YES in step S104), the processing shifts to step S119. On the other hand, when the authentication unit 104 fails in the second confirmation processing, that is, when the card ID acquired in step S100 is not stored in the storage unit 102 (NO in step S104), the processing shifts to step S105.

In step S105, the storage processing unit 101 causes the storage unit 102 to store, in association with each other, the card ID acquired in step S100 and the user ID acquired in step S101. After step S105, the processing shifts to step S119.

When the processing shifts to step S106, in step S106, the authentication unit 104 determines whether a cause of the failure of the first confirmation processing in step S101 is an error in communication with the cloud server 200. When the cause of the failure of the first confirmation processing is the communication error (YES in step S106), the processing shifts to step S107. In contrast, when the cause of the failure of the first confirmation processing is not the communication error (NO in step S106), the processing shifts to step S110.

In step S107, the authentication unit 104 executes the second confirmation processing. That is, the authentication unit 104 checks whether the card ID acquired in step S100 is stored in the storage unit 102. When the authentication unit 104 succeeds in the second confirmation processing, that is, when the card ID acquired in step S100 is stored in the storage unit 102 (YES in step S108), the processing shifts to step S119. In contrast, when the authentication unit 104 fails in the second confirmation processing, that is, when the card ID acquired in step S100 is not stored in the storage unit 102 (NO in step S108), the processing shifts to step S109. In step S109, the authentication unit 104 determines the authentication as failure. The authentication unit 104 determines as explained above because, although a reason of failing in confirming that the card ID of the card of the user U is registered in the cloud server 200 is the communication error, it cannot be exceptionally determine authentication as success because the card ID has not been found in the image forming apparatus 100 either. When the authentication is determined as failure, the processing ends and the user U, who is the target user, cannot use the image forming apparatus 100.

When the processing shifts to step S110, the authentication unit 104 executes the second confirmation processing in step S110. That is, the authentication unit 104 checks whether the card ID acquired in step S100 is stored in the storage unit 102. When the authentication unit 104 succeeds in the second confirmation processing, that is, when the card ID acquired in step S100 is stored in the storage unit 102 (YES in step S111), the processing shifts to step S112. In contrast, when the authentication unit 104 fails in the second confirmation processing, that is, when the card ID acquired in step S100 is not stored in the storage unit 102 (NO in step S111), the processing shifts to step S115.

In step S112, the authentication unit 104 executes the third confirmation processing. In the third confirmation processing, first, the authentication unit 104 finds a token stored in the storage unit 102 in association with the card ID acquired in step S100 and inquires the cloud server 200 about a user ID registered in the cloud server 200 in correlation with the token. Specifically, the authentication unit 104 requests the cloud server 200 to transmit the user ID corresponding to the token. Subsequently, the authentication unit 104 checks whether the user ID acquired from the cloud server 200 coincides with the user ID stored in the storage unit 102 in association with the card ID acquired in step S100. When the authentication unit 104 succeeds in the third confirmation processing, that is, when the acquisition of the user ID from the cloud server 200 is successful and the acquired user ID coincides the user ID stored in the storage unit 102 in association with the card ID acquired in step S100 (YES in step S113), the processing shifts to step S119. In contrast, when the authentication unit 104 fails in the third confirmation processing (NO in step S113), the processing shifts to step S114. That is, when the authentication unit 104 fails in the acquisition of the user ID from the cloud server 200 or when the acquired user ID is different from the user ID stored in the storage unit 102 in association with the card ID acquired in step S100, the processing shifts to step S114.

In step S114, the storage processing unit 101 deletes invalid information. Specifically, the storage processing unit 101 deletes information stored in the storage unit 102 in association with the card ID acquired in step S100. After step S114, the processing shifts to step S115.

In step S115, the authentication unit 104 urges the user U to perform input operation for login information for use of the cloud service, that is, authentication operation for logging in to the cloud service. In response to the operation, the user U performs, for example, via the UI device 152, operation of inputting the login information. Whether the login information input by the user U is legitimate information is determined by the cloud server 200. When the login information is legitimate information, the user U succeeds in the login to the cloud service. In step S116, the authentication unit 104 determines whether the user U has succeeded in the login to the cloud service. When the user U has succeeded in the login to the cloud service (YES in step S116), the processing shifts to step S118. On the other hand, when the authentication unit 104 fails in the login to the cloud service (NO in step S116), the processing shifts to step S117. In step S117, the authentication unit 104 determines the authentication as failure. When the authentication is determined as failure, the processing ends and the user U, who is the target user, cannot use the image forming apparatus 100.

On the other hand, when the user U has succeeded in the login to the cloud service, in step S118, the storage processing unit 101 performs anew processing of storing information concerning the target user in the storage unit 102. Specifically, the storage processing unit 101 causes the storage unit 102 to store a user ID and a token acquired from the cloud service and issuance point in time information of the token in association with the card ID acquired in step S100.

When the processing shifts to step S119, the authentication unit 104 determines the authentication as success. When the authentication is determined as success, the user U, who is the target user, can use the image forming apparatus 100. The processing shifts from step S104 or step S105 to step S119 and the authentication is determined as success because the authentication unit 104 has succeeded in the first confirmation processing in both the steps. That is, this is because it has been confirmed that the card ID input to the image forming apparatus 100 is registered in the cloud server 200. When the processing shifts from step S108 to step S119, although the authentication unit 104 has failed in the first confirmation processing, the authentication is exceptionally determined as success. This is because the failure cause of the first confirmation processing is merely the communication error and it has been successfully confirmed that the card ID acquired in step S100 is managed in the image forming apparatus 100. That is, this is because, from such a fact, the target user can be inferred as a legitimate user of the image forming apparatus 100. When the processing transitions from step S113 to step S119, although the authentication unit 104 has failed in the first confirmation processing, the authentication is also exceptionally determined as success. This is because, although the failure cause of the first configuration processing is not the communication error, it has been successfully confirmed that the card ID acquired in step S100 is managed in the image forming apparatus 100 and it has been successfully confirmed that the user ID linked with the card ID is also registered in the cloud server 200. That is, this is because, from such a fact, the target user can be inferred as a legitimate user of the image forming apparatus 100. When the processing transitions from step S118 to step S119, although the authentication unit 104 has failed in the first confirmation processing, the authentication is also determined as success. This is because it is confirmed based on the login information that the target user (the user U) is a legitimate user of the cloud service.

After step S119, the processing shifts to step S120. In step S120, the service use unit 105 performs, according to an instruction from the target user (the user U), processing of using a cloud service provided by the cloud server 200. At this time, when a token stored in association with the card ID acquired in step S100 is present in the storage unit 102, the service use unit 105 uses the cloud service using the token. In this case, a new token is acquired and the storage processing unit 101 updates the token and the issuance point in time information in the storage unit 102. In this flowchart, the processing of the service use unit 105 is described in step S120. However, the processing of the apparatus function use unit 106 may be performed in step S120.

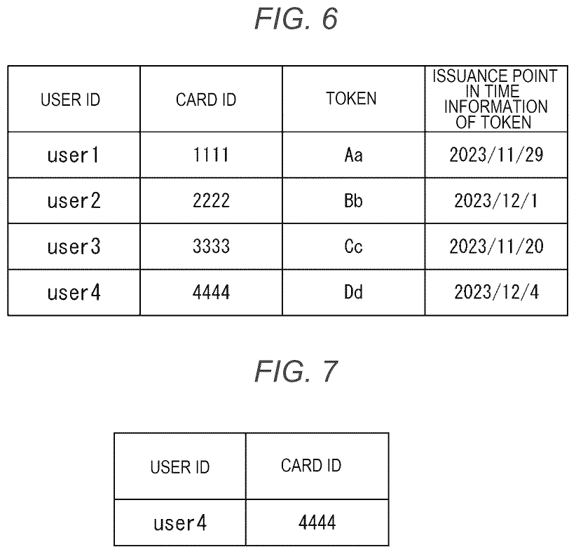

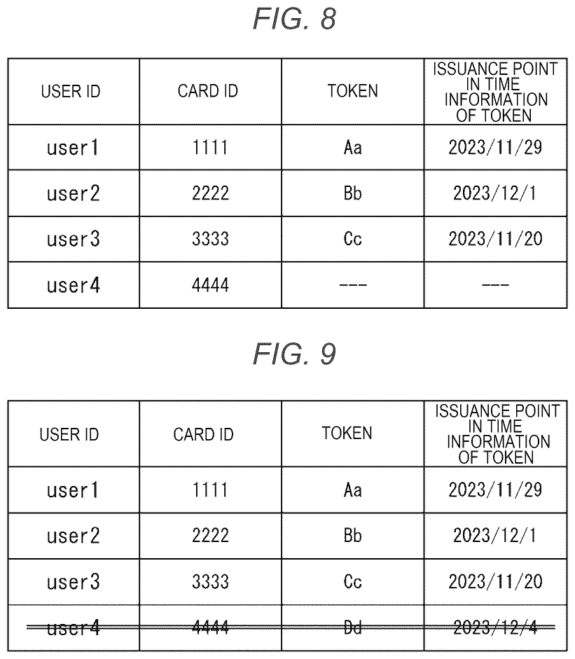

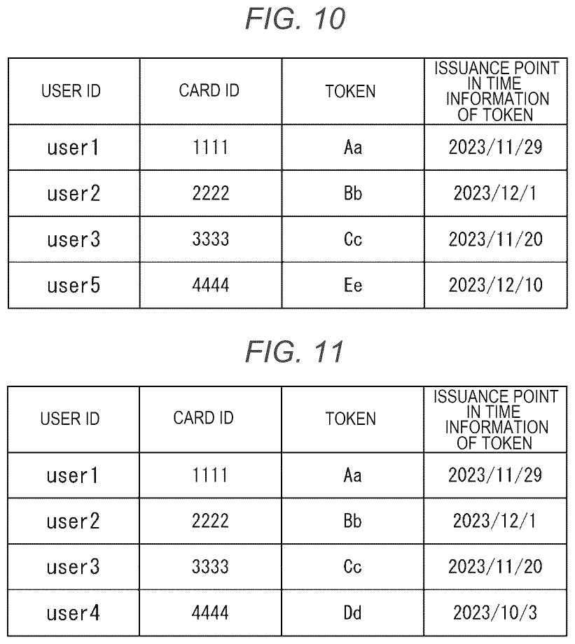

Subsequently, to assist understanding of the image forming apparatus 100 explained above, several specific examples are explained. In explaining the specific examples, FIG. 3 and FIGS. 6 to 11 are referred to as appropriate. FIG. 6 is a diagram illustrating a specific example of information stored in the storage unit 102. FIG. 7 is a diagram illustrating a specific example of information acquired from the cloud server 200 in the first confirmation processing. FIG. 8 is a diagram illustrating a specific example of information stored in the storage unit 102. FIG. 9 is a diagram schematically illustrating deletion of invalid information. FIG. 10 is a diagram illustrating a specific example of information stored in the storage unit 102. FIG. 11 is a diagram illustrating a specific example of information stored in the storage unit 102.

### Case 1

A case 1 is an example of a case in which a user whose card ID has been registered in the cloud server 200 by the administrator and whose user ID, card ID, a token, and issuance point in time information are stored in the storage unit 102 is an authentication target user U. For example, when a user who has become an authentication target user in a case 7 explained below uses the image forming apparatus 100 again, the user is the authentication target user in the case 1. A flow of the case 1 explained below corresponds to the processing flow reaching step S119 through steps S100, S101, S102, S103, and S104 explained above.

As a premise of the case 1, it is assumed that the information illustrated in FIG. 6 is stored in the storage unit 102 and “4444” is acquired as the card ID in step S100. At this time, in the case 1, the authentication unit 104 succeeds in the first confirmation processing (step S101) (YES in Step S102) and the authentication unit 104 acquires the user information illustrated in FIG. 7 as an example from the cloud server 200. That is, the authentication unit 104 acquires “user 4” as a user ID corresponding to the card ID “4444”. Thereafter, the second confirmation processing (step S103) is performed. Since the card ID “4444” is stored in the storage unit 102, the second confirmation processing is successful (YES in step S104). Therefore, the processing in step S105 is not performed and the authentication is determined as success (step S119). Thereafter, the service use unit 105 uses the cloud service using a token “Dd” stored in the storage unit 102 (step S120). That is, the user U can use the cloud service without performing input operation for the login information of the cloud service.

### Case 2

A case 2 is an example of a case in which a user whose card ID is registered in the cloud server 200 by the administrator but whose information is not stored in the storage unit 102 is the authentication target user U. A flow of the case 2 explained below corresponds to the processing flow reaching step S119 through steps S100, S101, S102, S103, S104, and S105 explained above.

As a premise of the case 2, it is assumed that the information illustrated in FIG. 3 is stored in the storage unit 102 and “4444” is acquired as the card ID in step S100. At this time, in the case 2, the authentication unit 104 succeeds in the first confirmation processing (step S101) (YES in Step S102) and the authentication unit 104 acquires the user information illustrated in FIG. 7 as an example from the cloud server 200. That is, the authentication unit 104 acquires “user 4” as a user ID corresponding to the card ID “4444”. Thereafter, the second confirmation processing (step S103) is performed. Since the card ID “4444” is not stored in the storage unit 102, the second confirmation processing is unsuccessful (NO in step S104). For this reason, the storage processing unit 101 causes the storage unit 102 to store the card ID “4444” and the user ID “user 4” acquired from the cloud server 200 in association with each other as illustrated in FIG. 8 (step S105). Then, the authentication unit 104 determines the authentication as success (step S119). In the present case, since a token is not stored in the storage unit 102 yet, when using the cloud service (step S120), the user U needs to perform input operation for login information of the cloud service.

### Case 3

A case 3 is an example of a case in which a user whose user ID, card ID, token, and issuance point in time information are stored in the storage unit 102 is the authentication target user U and the image forming apparatus 100 and the cloud server 200 cannot communicate with each other. For example, when a communication failure has occurred when the user who has become the authentication target user in the case 7 explained below uses the image forming apparatus 100 again, this corresponds to the present case. A flow of the case 3 explained below corresponds to a processing flow reaching step S119 through steps S100, S101, S102, S106, S107, and S108 explained above.

As a premise of the case 3, it is assumed that the information illustrated in FIG. 6 is stored in the storage unit 102 and “4444” is acquired as the card ID in step S100. At this time, in the case 3, the authentication unit 104 fails in the first confirmation processing (step S101) because of a communication error (NO in step S102, YES in step S106) and the second confirmation processing (step S107) is performed. Since the card ID “4444” is stored in the storage unit 102, the second confirmation processing is successful (YES in step S108). In the present case, although the authentication unit 104 has failed in the first confirmation processing, since a failure cause is merely the communication error and the authentication unit 104 succeeds in the second confirmation processing, the authentication is exceptionally determined as success (step S119). Thereafter, the service use unit 105 uses the cloud service using a token “Dd” stored in the storage unit 102 (step S120). That is, the user U can use the cloud service without performing input operation for the login information of the cloud service.

### Case 4

A case 4 is an example of a case in which a user whose information is not stored in the storage unit 102 is the authentication target user U and the image forming apparatus 100 and the cloud server 200 cannot communicate with each other. A flow of the case 4 explained below corresponds to a processing flow reaching step S109 through steps S100, S101, S102, S106, S107, and S108 explained above.

As a premise of the case 4, it is assumed that the information illustrated in FIG. 3 is stored in the storage unit 102 and “4444” is acquired as the card ID in step S100. At this time, in the case 4, the authentication unit 104 fails in the first confirmation processing (step S101) because of the communication error (NO in Step S102, YES in Step S106) and the second confirmation processing (step S107) is performed. Since the card ID “4444” is not stored in the storage unit 102, the second confirmation processing is also unsuccessful (NO in step S108). For this reason, the authentication cannot be exceptionally determine as success and the authentication is determined as failure (step S109).

### Case 5

A case 5 is an example of a case in which a user whose card ID is not registered in the cloud server 200 by the administrator and whose user ID, card ID, token, and issuance point in time information are stored in the storage unit 102 is the authentication target user U. However, it is assumed that, although the card ID of the user U is not registered in the cloud server 200, the user U is registered in the cloud server 200 as a legitimate user of the cloud service. The use of the cloud service does not require registration of a card ID in the cloud server 200. Therefore, a situation in which a card ID of a legitimate user of the cloud service is not stored in the cloud server 200 can occur. In the present case, as explained above, it is assumed that the user ID and the card ID of the user U are stored in the storage unit 102. The use ID and the card ID are stored in advance in the storage unit 102 of the image forming apparatus 100 by, for example, registration operation of the user U himself/herself or registration operation of the administrator. The storage unit 102 also stores a token and issuance point in time information of the token in association with the user ID and the card ID of the user U. For example, as the token and the issuance point in time information, information concerning the token issued when the user U succeeds in login to the cloud service by input operation of login information performed before occurrence of the case 5 is stored. A flow of the case 5 explained below corresponds to a processing flow reaching step S119 through steps S100, S101, S102, S106, S110, S111, S112, and S113 explained above.

As a premise of the case 5, it is assumed that the information illustrated in FIG. 6 is stored in the storage unit 102 and “4444” is acquired as the card ID in step S100. At this time, since the card ID “4444” is not registered in the cloud server 200 in the case 5, the authentication unit 104 fails in the first confirmation processing (step S101) (NO in step S102). That is, the first confirmation processing is unsuccessful because of a reason other than the communication error (NO in step S106). Thereafter, the second confirmation processing (step S110) is performed. Since the card ID “4444” is stored in the storage unit 102, the second confirmation processing is successful (YES in step S111). In the present case, thereafter, the third confirmation processing is performed (step S112). Since the token stored in the storage unit 102 in association with the card ID “4444” is “Dd”, in the third confirmation processing, acquisition of the user ID of the user registered in the cloud server 200 in correlation with the token “Dd” is attempted. Here, it is assumed that the user ID “user 4” is acquired from the cloud server 200 in the third confirmation processing. Since the user ID “user 4” acquired from the cloud server 200 coincides with the user ID “user 4” stored in the storage unit 102 in association with the card ID “4444”, in the present case, the authentication unit 104 succeeds in the third confirmation processing (YES in step S113). Accordingly, in the present case, the authentication is determined as success (step S119). That is, although the failure cause of the first confirmation processing is not the communication error, since it is successfully confirmed that the card ID “4444” is present in the storage unit 102 and the user ID “user 4” linked with the card ID “4444” is registered in the cloud server 200 as well in the storage unit 102, the authentication is determined as success. Thereafter, the service use unit 105 uses the cloud service using a token “Dd” stored in the storage unit 102 (step S120). That is, the user U can use the cloud service without performing input operation for the login information of the cloud service.

### Case 6

A case 6 is an example of a case in which a card used by another user who previously had use qualification for the image forming apparatus 100 and the cloud service but does not currently has the use qualification (for example, a card of a retiree) is distributed to the authentication target user U. In the present case as well, it is assumed that the card ID of the card used by the authentication target user U is not registered in the cloud server 200 by the administrator. It is assumed that the storage unit 102 stores a user ID, a card ID, a token, and issuance point in time information of the other user who previously used the card. It is assumed that the user U is registered in the cloud server 200 as a legitimate user of the cloud service. It is assumed that, for the other user who previously used the card, user registration as the legitimate user of the cloud service is deleted from the cloud server 200. A flow of the case 6 explained below corresponds to a processing flow reaching step S119 through steps S100, S101, S102, S106, S110, S111, S112, S113, S114, S115, S116, and S118 explained above.

As a premise of the case 6, it is assumed that the information illustrated in FIG. 6 is stored in the storage unit 102 and “4444” is acquired as the card ID in step S100. At this time, in the case 6, since the card ID “4444” is not registered in the cloud server 200, the authentication unit 104 fails in the first confirmation processing (step S101) (NO in step S102). That is, the first confirmation processing is unsuccessful because of a reason other than the communication error (NO in step S106). Thereafter, the second confirmation processing (step S110) is performed. Since the card ID “4444” is stored in the storage unit 102, the second confirmation processing is successful (YES in step S111). In the present case as well, the third confirmation processing is performed (step S112). Since the token stored in the storage unit 102 in association with the card ID “4444” is “Dd”, in the third confirmation processing, acquisition of the user ID of the user registered in the cloud server 200 in correlation with the token “Dd” is attempted. Here, since the information concerning a user who previously possessed the card having the card ID “4444” is deleted from the cloud server 200, a user ID correlated with the token “Dd” is absent in the cloud server 200. For this reason, in the third confirmation processing, since the user ID cannot be acquired from the cloud server 200, the third confirmation processing is unsuccessful (NO in step S113). For this reason, invalid information is deleted from the storage unit 102 (step S114). Accordingly, as illustrated in FIG. 9, information concerning the card ID “4444” is deleted from the storage unit 102. Thereafter, the authentication unit 104 urges the user U to perform authentication operation involving input of login information. In response, the user U inputs the login information (step S115). Here, it is assumed that the user U has succeeded in the login to the cloud service (YES in step S116). Accordingly, processing of storing information concerning a target user in the storage unit 102 is performed anew (step S118). Accordingly, as illustrated in FIG. 10, a user ID “user 5” and a token “Ee” acquired from the cloud server 200 and issuance point in time information of the token are stored in the storage unit 102 in association with the card ID “4444”. In the present case, since the user has succeeded in the login to the cloud service, the authentication is determined as success (step S119). In this case, since the user U has succeeded in the login to the cloud service according to the input of the login information, the service use unit 105 can use the cloud service (step S120).

### Case 7

A case 7 is an example of a case in which a user whose card ID is not registered in the cloud server 200 by the administrator and whose information is not stored in the storage unit 102 either is the authentication target user U. However, it is assumed that, although the card ID of the user U is not registered in the cloud server 200, the user U is registered in the cloud server 200 as a legitimate user of the cloud service. That is, the authentication target user U of the present case is different from the authentication target user U of the case 2 explained above in that the card ID is not registered in the cloud server 200. A flow of the case 7 explained below corresponds to a processing flow reaching step S119 through steps S100, S101, S102, S106, S110, S111, S115, S116, and S118 explained above.

As a premise of the case 7, it is assumed that the information illustrated in FIG. 3 is stored in the storage unit 102 and “4444” is acquired as the card ID in step S100. At this time, in the case 7, since the card ID “4444” is not registered in the cloud server 200, the authentication unit 104 fails in the first confirmation processing (step S101) (NO in step S102). That is, the first confirmation processing is unsuccessful because of a reason other than the communication error (NO in step S106). Thereafter, the second confirmation processing (step S110) is performed. Since the card ID “4444” is not stored in the storage unit 102, the authentication unit 104 fails in the second confirmation processing (NO in step S111). For this reason, the authentication unit 104 urges the user U to perform authentication operation involving input of login information and, in response, the user U inputs the login information (step S115). Here, it is assumed that the user U has succeeded in the login to the cloud service (YES in step S116). Accordingly, processing of storing information concerning a target user in the storage unit 102 is performed anew (step S118). Accordingly, as illustrated in FIG. 6, the user ID “user 4” and the token “Dd” acquired from the cloud server 200 and issuance point in time information of the token are stored in the storage unit 102 in association with the card ID “4444”. In the present case, since the user has succeeded in the login to the cloud service, the authentication is determined as success (step S119). In this case, since the user U has succeeded in the login to the cloud service according to the input of the login information, the service use unit 105 can use the cloud service (step S120).

### Case 8

The case 8 is an example of a case in which a message is notified by the notification unit 107. As a premise of the case 8, it is assumed that the information illustrated in FIG. 11 is stored in the storage unit 102 and the present date is Dec. 23, 2023. It is assumed that the notification unit 107 notifies the message when there is a token, since issuance of which 80 days have elapsed. At this time, in the case 8, the notification unit 107 detects that 80 days have elapsed since issuance of a token of the user whose user ID is “user 4”. For example, this is detected by the notification unit 107 confirming issuance point in time information of users stored in the storage unit 102 when the image forming apparatus 100 is turned on. The notification unit 107 notifies, to the user whose user ID is “user 4”, a message for informing that a term of validity of the token will end soon. Specifically, the notification unit 107 acquires a mail address of the user from the cloud server 200 and transmits an e-mail including the message to the acquired mail address.

The embodiment is explained above. The image forming apparatus 100 according to the present embodiment acquires card information of a card possessed by a target user and uses a cloud service using a token stored in the storage unit 102 in association with the acquired card information. Therefore, the target user does not always need to perform authentication operation for using the cloud service. For this reason, convenience of a user for use of the cloud service is high.

As indicated in the case 6 or the case 7 explained above, in the present embodiment, when the target user has succeeded in the login to the cloud service via the image forming apparatus 100 by performing the authentication operation for logging in to the cloud service, the storage processing unit 101 performs processing explained below. That is, in this case, the storage processing unit 101 performs processing for storing, in the storage unit 102, in association with each other, the card information acquired by the card information acquisition unit 103 and the token acquired from the cloud service according to the login. For this reason, for the target user, the card information and the token are automatically stored in association with each other in the storage unit 102. For this reason, according to the present embodiment, information for using the cloud service without performing the authentication operation can be automatically stored in the storage unit 102.

In the present embodiment, as illustrated in steps S119 and S120, when the result of the authentication processing by the authentication unit 104 is authentication success, the service use unit 105 uses the cloud service using the token stored in the storage unit 102 in association with the card information acquired by the card information acquisition unit 103. For this reason, it is possible to suppress a fraud in the use of the cloud service using the token.

In the present embodiment, as indicated in the case 1 or the case 2, when the authentication unit 104 succeeds in the first confirmation processing, the authentication unit 104 determines that authentication as success in the authentication processing. That is, according to the confirmation that the user corresponding to the card information acquired by the card information acquisition unit 103 is registered in the cloud service, it is authenticated that the target user is a legitimate user of the image forming apparatus 100. Therefore, according to the present embodiment, it is possible to implement authentication processing associated with the cloud server 200 without requesting authentication operation for the cloud service.

In the present embodiment, as indicated in the case 3 explained above, when the authentication unit 104 fails in the first confirmation processing because of the error in communication with the cloud server 200, if the authentication unit 104 succeeds in the second confirmation processing, the authentication unit 104 determines the authentication as success in the authentication processing. Therefore, when the communication error occurs, the target user can be authenticated according to the information stored in the image forming apparatus 100. For this reason, the convenience of the user is improved.

In the present embodiment, as indicated in the case 2 explained above, when the authentication unit 104 succeeds in the first confirmation processing and fails in the second confirmation processing in the authentication processing by the authentication unit 104, the processing of storing the card information of the target user acquired by the card information acquisition unit 103 in the storage unit 102 is performed. Accordingly, the information (that is, the card information of the target user) for making the second confirmation processing, which performed when the authentication unit 104 fails in the first confirmation processing because of the communication error, successful for the target user is automatically stored in the storage unit 102. For this reason, the convenience of the user is improved.

In the present embodiment, as indicated in the case 5 explained above, when failing in the first confirmation processing because of a cause other than the error in communication with the cloud server 200, if succeeding in both of the second confirmation processing and the third confirmation processing, the authentication unit 104 determines the authentication as success in the authentication processing. Therefore, when card information is not registered in the cloud server 200 because of a reason, for example, because the administrator neglects the registration operation, it is inferred whether the target user is a legitimate user. For this reason, the convenience of the user is improved.

In the present embodiment, as indicated in the case 6 explained above, the storage processing unit 101 performs processing explained below. When failing in the first confirmation processing because of a cause other than the error in communication with the cloud server 200, succeeding in the second confirmation processing, and failing in the third confirmation processing, the storage processing unit 101 deletes information stored in the storage unit 102 in association with the card information acquired by the card information acquisition unit 103. Therefore, information that should be invalidated such as information concerning a retiree is deleted. Thus, it is possible to more securely operate the system.

Further, in the present embodiment, as indicated in the case 8 explained above, when the remaining term of validity of a token specified from the issuance point in time information stored in the storage unit 102 is less than a predetermined threshold, the notification unit 107 notifies a user corresponding to the token. For this reason, the convenience of the user is improved. In particular, in the present embodiment, when the user who has checked this message uses the cloud service via the image forming apparatus 100, a new token is issued. Therefore, it is possible to prevent the term of validity of the token from being expired. That is, it is possible to extend a period in which the cloud service can be used without performing the authentication operation.

The embodiment is above but the present disclosure is not limited to the embodiment explained above and can be changed as appropriate without departing from the gist of the present disclosure.

A part or the entire embodiment explained above can also be described as in the following appendixes but are not limited to the following.

### Appendix 1

An image forming apparatus connected to a server that provides a cloud service, the image forming apparatus including:
a storage unit configured to store, in association with each other, card information of a card distributed to a legitimate user of the image forming apparatus and a token for enabling use of the cloud service;
a card information acquisition unit configured to acquire card information of a card possessed by a target user who is a user about to use the cloud service via the image forming apparatus; and
a service use unit configured to use the cloud service using the token stored in the storage unit in association with the acquired card information.

### Appendix 2

The image forming apparatus described in the appendix 1, wherein, when the target user performs authentication operation for logging into the cloud service to thereby succeed in login to the cloud service via the image forming apparatus, the acquired card information and the token acquired from the cloud service according to the login are stored in the storage unit in association with each other.

### Appendix 3

The image forming apparatus described in appendix 1 or 2, further including an authentication unit configured to perform authentication processing of authenticating that the target user is a legitimate user of the image forming apparatus, wherein
when a result of the authentication processing is authentication success, the service use unit uses the cloud service using the token stored in the storage unit in association with the acquired card information.

### Appendix 4

The image forming apparatus described in the appendix 3, wherein
the authentication processing includes first confirmation processing of acquiring user identification information of the legitimate user of the cloud service registered in the server in correlation with the acquired card information, and
when succeeding in the first confirmation processing, the authentication unit determines authentication as success in the authentication processing.

### Appendix 5

The image forming apparatus described in the appendix 4, wherein
the authentication processing includes the first confirmation processing and second confirmation processing of confirming that the acquired card information is stored in the storage unit, and
when failing in the first confirmation processing because of an error in communication with the server, the authentication unit determines authentication as success in the authentication processing if succeeding in the second confirmation processing.

### Appendix 6

The image forming apparatus described in the appendix 5, wherein, when the authentication unit succeeds in the first confirmation processing and fails in the second confirmation processing, the acquired card information is stored in the storage unit.

### Appendix 7

The image forming apparatus described in any one of the appendixes 4 to 6, wherein
the storage unit stores user identification information in association with the card information,
the authentication processing includes:
the first confirmation processing;
second confirmation processing of confirming that the acquired card information is stored in the storage unit; and
third confirmation processing of acquiring user identification information of the legitimate user of the cloud service registered in the server in correlation with the token stored in the storage unit in association with the acquired card information and confirming that the acquired user identification information coincides with the user identification information stored in the storage unit in association with the card information, and
when failing in the first confirmation processing because of a cause other than an error in communication with the server, the authentication unit determines authentication as success in the authentication processing if succeeding in both of the second confirmation processing and the third confirmation processing.

### Appendix 8

The image forming apparatus described in the appendix 7, wherein, when the authentication unit fails in the first confirmation processing because of a cause other than the error in communication with the server, succeeds in the second confirmation processing, and fails in the third confirmation processing, information stored in the storage unit in association with the acquired card information is deleted.

### Appendix 9

The image forming apparatus described in any one of the appendixes 1 to 8, wherein
the token is valid until a predetermined time elapses from an issuance point in time of the token,
the storage unit further stores issuance point in time information indicating the issuance point in time of the token in association with the token, and
the image forming apparatus further includes a notification unit configured to notify a user corresponding to the token when a remaining term of validity of the token specified from the issuance point in time information is less than a predetermined threshold.

### Appendix 10

An information processing method of an image forming apparatus connected to a server that provides a cloud service, the information processing method including:
storing, in association with each other, card information of a card distributed to a legitimate user of the image forming apparatus and a token for enabling use of the cloud service;
acquiring card information of a card possessed by a target user who is a user about to use the cloud service via the image forming apparatus; and
using the cloud service by using the token stored in association with the acquired card information.

### Appendix 11

A non-transitory computer-readable storage medium storing a program for causing a computer of an image forming apparatus connected to a server, which provides a cloud service, to execute:
a storage processing step of storing, in association with each other, in a storage unit, card information of a card distributed to a legitimate user of the image forming apparatus and a token for enabling use of the cloud service;
a card information acquisition step of acquiring card information of a card possessed by a target user who is a user about to use the cloud service via the image forming apparatus; and
a service use step of using the cloud service by using the token stored in the storage unit in association with the acquired card information.

What is claimed is:

1. An image forming apparatus connected to a server that provides a cloud service, the image forming apparatus including:
a storage configured to store, in association with each other, card information of a card distributed to a legitimate user of the image forming apparatus and a token for enabling use of the cloud service;
a card information acquisition unit configured to acquire card information of a card possessed by a target user who is a user about to use the cloud service via the image forming apparatus; and
a service use unit configured to use the cloud service using the token stored in the storage in association with the acquired card information.

2. The image forming apparatus according to claim 1, wherein, when the target user performs authentication operation for logging into the cloud service to thereby succeed in login to the cloud service via the image forming apparatus, the acquired card information and the token acquired from the cloud service according to the login are stored in the storage in association with each other.

3. The image forming apparatus according to claim 1, further comprising an authentication unit configured to perform authentication processing of authenticating that the target user is a legitimate user of the image forming apparatus, wherein
when a result of the authentication processing is authentication success, the service use unit uses the cloud service using the token stored in the storage in association with the acquired card information.

4. The image forming apparatus according to claim 3, wherein
the authentication processing includes first confirmation processing of acquiring user identification information of the legitimate user of the cloud service registered in the server in correlation with the acquired card information, and
when succeeding in the first confirmation processing, the authentication unit determines authentication as success in the authentication processing.

5. The image forming apparatus according to claim 4, wherein
the authentication processing includes the first confirmation processing and second confirmation processing of confirming that the acquired card information is stored in the storage, and
when failing in the first confirmation processing because of an error in communication with the server, the authentication unit determines authentication as success in the authentication processing if succeeding in the second confirmation processing.

6. The image forming apparatus according to claim 5, wherein, when the authentication unit succeeds in the first confirmation processing and fails in the second confirmation processing, the acquired card information is stored in the storage.

7. The image forming apparatus according to claim 4, wherein
the storage stores user identification information in association with the card information,
the authentication processing includes:
the first confirmation processing;
second confirmation processing of confirming that the acquired card information is stored in the storage; and
third confirmation processing of acquiring user identification information of the legitimate user of the cloud service registered in the server in correlation with the token stored in the storage in association with the acquired card information and confirming that the acquired user identification information coincides with the user identification information stored in the storage in association with the card information, and
when failing in the first confirmation processing because of a cause other than an error in communication with the server, the authentication unit determines authentication as success in the authentication processing if succeeding in both of the second confirmation processing and the third confirmation processing.

8. The image forming apparatus according to claim 7, wherein, when the authentication unit fails in the first confirmation processing because of a cause other than the error in communication with the server, succeeds in the second confirmation processing, and fails in the third confirmation processing, information stored in the storage in association with the acquired card information is deleted.

9. The image forming apparatus according to claim 1, wherein
the token is valid until a predetermined time elapses from an issuance point in time of the token,
the storage further stores issuance point in time information indicating the issuance point in time of the token in association with the token, and
the image forming apparatus further includes a notification unit configured to notify a user corresponding to the token when a remaining term of validity of the token specified from the issuance point in time information is less than a predetermined threshold.

10. An information processing method of an image forming apparatus connected to a server that provides a cloud service, the information processing method including:
storing, in association with each other, card information of a card distributed to a legitimate user of the image forming apparatus and a token for enabling use of the cloud service;
acquiring card information of a card possessed by a target user who is a user about to use the cloud service via the image forming apparatus; and
using the cloud service by using the token stored in association with the acquired card information.

11. A non-transitory computer-readable storage medium storing a program for causing a computer of an image forming apparatus connected to a server, which provides a cloud service, to execute:
a storage processing step of storing, in association with each other, in a storage, card information of a card distributed to a legitimate user of the image forming apparatus and a token for enabling use of the cloud service;
a card information acquisition step of acquiring card information of a card possessed by a target user who is a user about to use the cloud service via the image forming apparatus; and
a service use step of using the cloud service by using the token stored in the storage in association with the acquired card information.
